(19) United States
(12) Patent Application Publication
(10) Pub. No.: US 2015/0270667 A1
(43) Pub. Date: Sep. 24, 2015

(54) STYLUS

(71) Applicant: Rich Electric Wire and Cable Co. Ltd., Yunlin County (TW)

(72) Inventor: Chang-Chi LEE, Yunlin County (TW)

(73) Assignee: Rich Electric Wire and Cable Co. Ltd., Yunlin County (TW)

(21) Appl. No.: 14/223,542

(22) Filed: Mar. 24, 2014

(51) Int. Cl. H01R 31/06; H01R 13/52

(52) U.S. Cl. CPC H01R 31/06; H01R 13/5213

(57) ABSTRACT

A stylus includes a shaft, a head, and a connector unit. The shaft has a conductive jacket. The head is connected to an end of the shaft and has a conductive skin layer to be electrically connected to the jacket. The connector unit is provided to the shaft and insulated from the jacket and the conductive skin layer. The connector unit has a first connector and a second connector electrically connected to each other. Therefore, except for controlling a touch screen, the connector unit of the stylus may serves as a cable to connect two electronic devices.

### BACKGROUND OF THE INVENTION

1. Technical Field

The present invention relates generally to an input device for a touch screen, and more particularly to a stylus with universal serial bus connection.

2. Description of Related Art

Touch screen is an electronic visual display widely used in modern electronic devices, such as ATM machine, laptop, smartphone, and tablet, for inputting commands and displaying images. User can control a specified application executed in the electronic device by touching the screen with a special stylus and/or finger.

Typically, touch screens are classified into resistive touch screens and capacitive touch screens, and the capacitive touch screens are more popular than the resistive touch screens. Since the human body is an electrical conductor, when one touches the surface of the capacitive touch screen, it results in a distortion of the screen's electrostatic field, measurable as a change in capacitance. Unlike resistive touch screens, one can control the capacitive touch screen simply by fingers. However, it is difficult to precisely touch a small icon on the touch screen by finger, and sweet will get the surface of the screen dirty. Stylus is a pen-like input device to input commands by touching the surface of the touch screen. Although styluses are widely used as the input device of the touch screen, they still need to be improved.

### BRIEF SUMMARY OF THE INVENTION

In view of the above, the primary objective of the present invention is to provide a stylus, which is incorporated with universal serial bus to have multi functions.

The present invention provides a stylus includes a shaft, a head, and a connector unit. The shaft has a conductive jacket. The head is connected to an end of the shaft and has a conductive skin layer to be electrically connected to the jacket. The connector unit is provided to the shaft and insulated from the jacket and the conductive skin layer. The connector unit has a first connector and a second connector electrically connected to each other.

In an embodiment, the shaft has a shaft body, which is made of an insulating material. The shaft body has a first end and a second end, wherein the first connector is provided on the first end, and the second connector is provided on the second end. The connector unit further has a wire with opposite ends connected to the first connector and the second connector respectively. The wire is received in the shaft body.

In an embodiment, the jacket is provided on a surface of the shaft body. The head is provided with a slot on an inner side thereof, and an insulating inner layer on a sidewall of the slot; the first connector detachably engages the slot of the head, and the conductive skin layer is provided on an outer side of the head.

In an embodiment, the stylus further includes a conductive connecting wire with opposite ends connected to the jacket of the shaft and the conductive skin layer of the head.

In an embodiment, the wire has an extending section extending out of the shaft body, and the second connector is connected to an end of the extending section.

In an embodiment, the shaft further includes a tube, and the tube is detachably fitted onto the shaft body. The jacket is provided on a surface of the tube, and the head is connected to an end of the tube.

In an embodiment, the shaft has a first member and a second member. The jacket is provided on a surface of the first member. The first member has a room therein, and the room is open at a rear end of the first member. The connector unit is received in the room. The second member detachably engages the first member to close the room. The head is connected to a front end of the first member.

In an embodiment, the connector unit further has a wire with opposite ends connected to the first connector and the second connector respectively.

In an embodiment, the jacket is made of conductive PET, conductive TPR, conductive PE, conductive PVC, or conductive PP.

In an embodiment, the conductive skin layer of the head is made of conductive silicone.

Therefore, except for controlling a touch screen, the connector unit of the stylus may serve as a cable to connect two electronic devices.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is an exploded view of a first preferred embodiment of the present invention;

FIG. 2 is a perspective view of the first preferred embodiment of the present invention;

FIG. 3 is a perspective view of a second preferred embodiment of the present invention;

FIG. 4 is a perspective view of a third preferred embodiment of the present invention;

FIG. 5 is a right view of the third preferred embodiment of the present invention;

FIG. 6 is an exploded view of a fourth preferred embodiment of the present invention; and

FIG. 7 is an exploded view of a fifth preferred embodiment of the present invention.

### DETAILED DESCRIPTION OF THE INVENTION

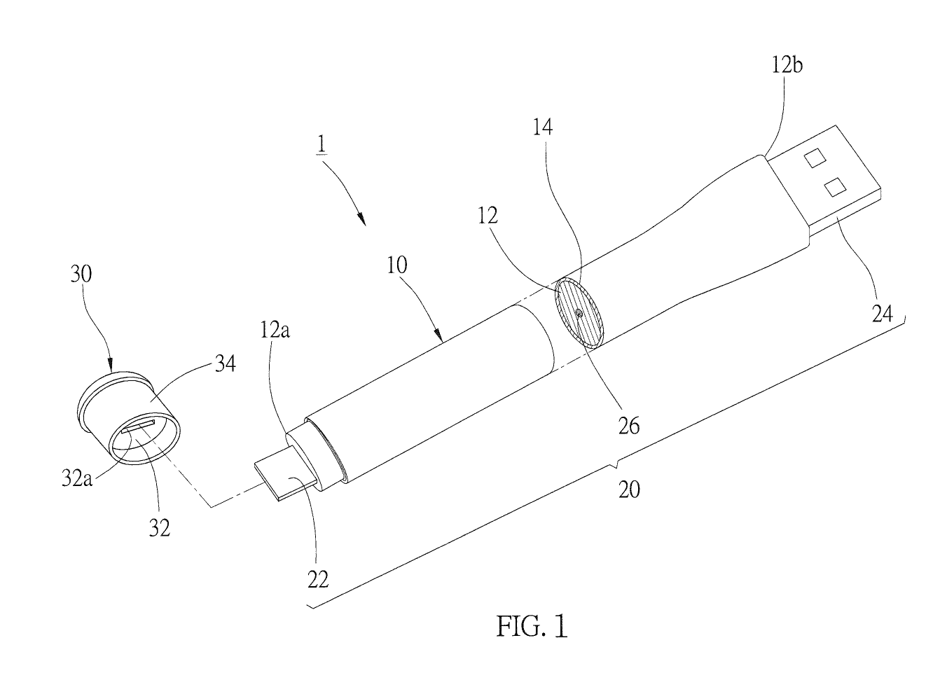

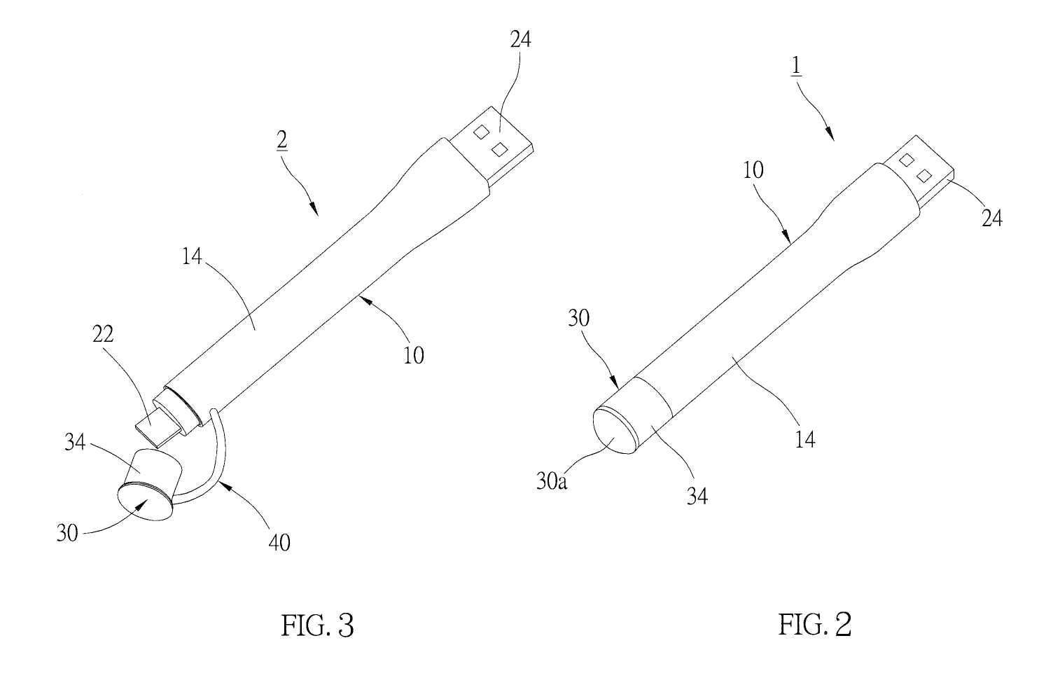

As shown in FIG. 1 and FIG. 2, a stylus 1 of the first preferred embodiment of the present invention includes a shaft 10, a connector unit 20 and a head 30.

The shaft 10 is designated to be held by user, and has shaft body 12 and a jacket 14. The shaft body 12 is made of an insulating material, which means the shaft body 12 is an insulator. The shaft body 12 has a first end 12a and a second end 12b. The jacket 14 is made of a conductive plastic, such as conductive PET, conductive TPR, conductive PE, conductive PVC, and conductive PP. The jacket 14 is coated on a surface of the shaft body 12. Human's skin will touch the jacket 14 while he/she is holding the shaft 10.

The connector unit 20 includes a first connector 22, a second connector 24, and a wire 26. The first connector 22 is fixed to the first end 12a of the shaft body 12, and the second connector 24 is fixed to the second end 12b. The wire 26 has opposite ends connected to the first connector 22 and the second connector 24 respectively. The wire 26 is received in the shaft body 12, and is insulated from the jacket 14 because of the insulating shaft body 12. In an embodiment, the first connector 22 and the second connector 24 are two connectors with different specifications to connect to various electronic devices, such as smartphone, computer, digital television, play station, and camera.

The head 30 is coated with an insulating inner layer 32 on an inner side thereof and a conductive skin layer 34 on an outer side. The head 30 is provided with a slot 32a on the inner side to engage the first connector 22. Therefore, the head 30 is detachably connected to the shaft 10 by engaging the slot 32a with the first connector 22, and the first connector 22 is covered by the head 30. The insulating inner layer 32 is on a sidewall of the slot 32a as well to insulate the first connector 22 from the conductive skin layer 34. The head 30 has a round tip 30a at a front end, and the tip 30a is covered by the conductive skin layer 34. In an embodiment, the conductive skin layer 34 is made of conductive silicone, which is conductive and flexible to avoid the tip 30a damaging the touch screen.

When the head 30 is connected to the shaft 10, the conductive skin layer 34 is electrically connected to the jacket 14, therefore a fine current of human body will be conducted to the conductive skin layer 34 to control the touch screen while a user is holding the shaft 10 and touches the touch screen with the tip 30a of the head 30. In an embodiment, the first connector 22 is a mini USB plug, and the second connector 24 is a USB plug. When the head 30 is removed, the shaft 10 becomes a USB cable for connecting two electronic devices.

In an embodiment, the jacket 14 is provided on a specific portion of the surface of the shaft 10, which is designated for user to hold it, rather than the entire surface. It may reduce the cost. Except for conductive plastic, any conductor, such as aluminum, may be used for the jacket 14 and the conductive skin layer 34.

FIG. 3 shows a stylus 2 of the second preferred embodiment of the present invention, which is basically the same as the stylus 1 of the first preferred embodiment, except that a connecting wire 40 is provided to connect the head 30 and the jacket 14 of the shaft 10. The connecting wire 40 is conductive to electrically connect the head 30 to the jacket 14, and keeps the head 30 with the shaft 10 when the head 30 is taken off.

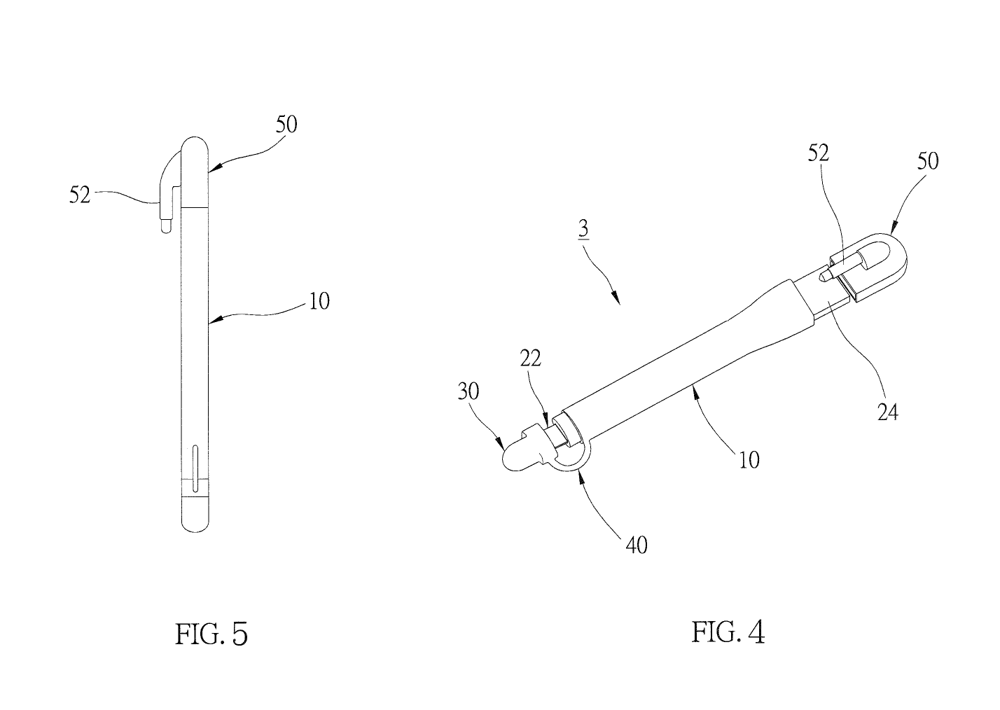

FIG. 4 and FIG. 5 show a stylus 3 of the third preferred embodiment of the present invention, which is basically the same as the stylus 2 of the second preferred embodiment, except that the stylus 3 further includes a lid 50 to cover the second connector 24. The lid 50 has a hook 52 to hang the stylus 3 in a pocket or a suitcase. The lid 50 may be incorporated in the stylus 1 of the first preferred embodiment as well.

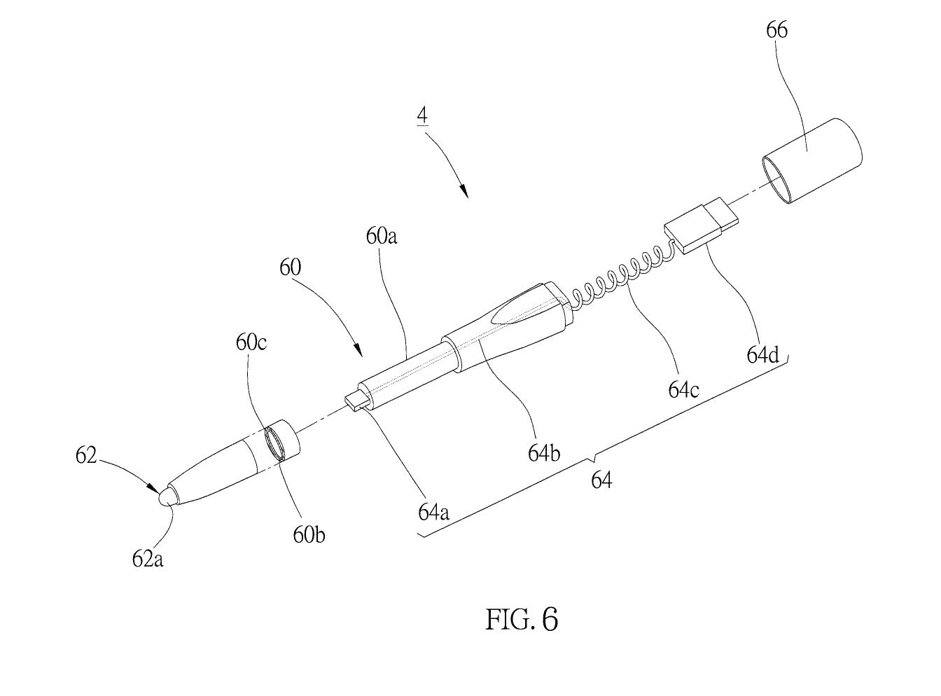

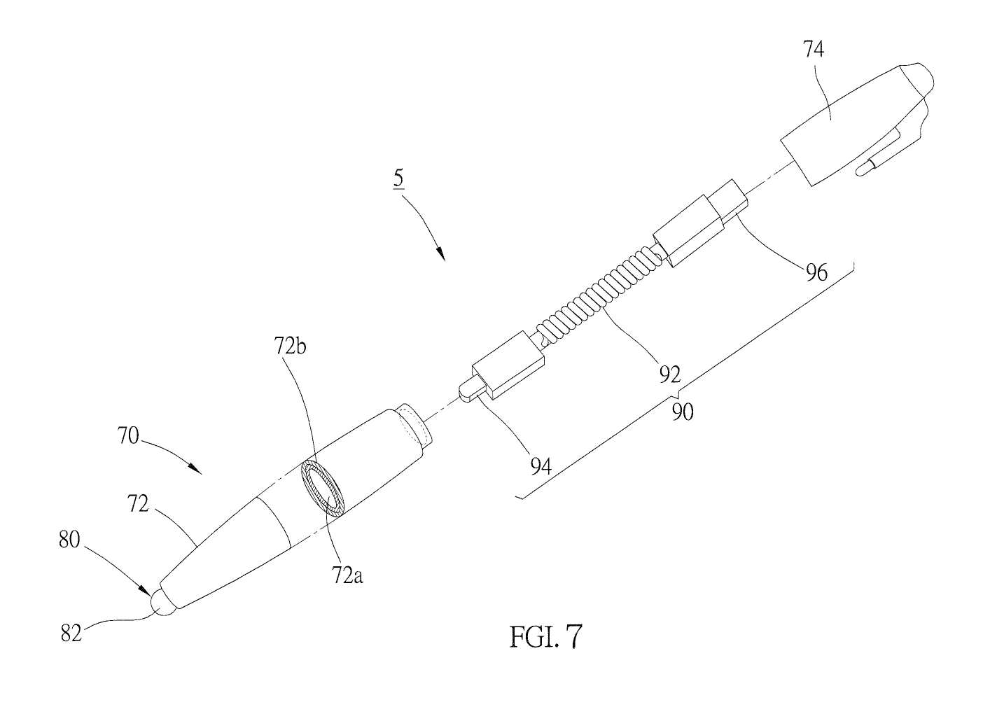

FIG. 6 shows a stylus 4 of the fourth preferred embodiment of the present invention, in which a shaft 60 includes a shaft body 60a and a tube 60b, and a jacket 60c is provided on a surface of the tube 60b. The tube 60b is detachably fitted to the shaft body 60a via a front end thereof. The stylus 4 has a head 62 which is fixed to a front end of the tube 60b. The head 62 has a conductive skin layer 62a on an outer side thereof, and the skin layer 62a is electrically connected to the jacket 60c. In an embodiment, the head 62 and the tube 60b are made into a single unit, and the conductive skin layer 62a and the jacket 60c are a layer coated thereon. A fine current of human body is conducted to the conductive skin layer 62a of the head 62 when a user holds the shaft 60. A connector unit 64 has a first connector 64a, a second connector 64d, and a wire 64b. The first connector 64a is fixed to a rear end of the shaft body 60a. The wire 64b has an end connected to the first connector 64a, a section embedded in the shaft body 60a, and an extending section 64c left out of the shaft body 60a. The extending section 64c is spiral, and is connected to the second connector 64d. A distance between the first connector 64a and the second connector 64d is adjustable because of the spiral extending section 64c. The stylus 4 further has a lid 66 engaging the rear end of the shaft body 60a to cover the second connector 64d and the extending section 64c of the wire 64b.

FIG. 7 shows a stylus 5 of the fifth preferred embodiment of the present invention, which is basically the same as the styluses of above, except that a shaft 70 has a first member 72 and a second member 74. The first member 72 has a room 72a therein, and the room 72a is open at a rear end of the first member 72. The first member 72 is provided with a jacket 72b on a surface thereof and a head 80 at a front end thereof. The head 80 has a conductive skin lay 82 on a surface thereof, and the conductive skin lay 82 is electrically connected to the jacket 72b. The second member 74 engages the first member 72 at the rear end to close the room 72a. The connector unit 90 has a first connector 94, a second connector 96, and a spiral wire 92. The whole connector unit 90 is received in the room 72a of the first member 72. The connector unit 90 is taken out of the room 72a when the first member 72 and the second member 74 are disengaged. The same as above, the spiral wire 92 may adjust a distance between the first connector 94 and the second connector 96.

It must be pointed out that the embodiments described above are only some preferred embodiments of the present invention. All equivalent structures and methods which employ the concepts disclosed in this specification and the appended claims should fall within the scope of the present invention.

What is claimed is:

1. A stylus, comprising:
a shaft having a jacket, wherein the jacket is conductive;
a head connected to an end of the shaft and having a conductive skin layer, wherein the conductive skin layer is electrically connected to the jacket; and
a connector unit provided to the shaft and insulated from the jacket and the conductive skin layer, wherein the connector unit has a first connector and a second connector electrically connected to each other.

2. The stylus of claim 1, wherein the shaft has a shaft body, which is made of an insulating material, and the shaft body has a first end and a second end; the first connector is provided on the first end of the shaft body, and the second connector is provided on the second end of the shaft body; the connector unit further has a wire with opposite ends connected to the first connector and the second connector respectively; the wire is received in the shaft body.

3. The stylus of claim 2, wherein the jacket is provided on a surface of the shaft body; the head is provided with a slot on an inner side thereof, and an insulating inner layer on a sidewall of the slot; the first connector detachably engages the slot of the head; the conductive skin layer is provided on an outer side of the head.

4. The stylus of claim 3, further comprising a connecting wire with opposite ends connected to the jacket of the shaft and the conductive skin layer of the head, wherein the connecting wire is conductive.

5. The stylus of claim 2, wherein the wire has an extending section extending out of the shaft body; and the second connector is connected to an end of the extending section.

6. The stylus of claim 2, wherein the shaft further includes a tube; the tube is detachably fitted onto the shaft body; the jacket is provided on a surface of the tube; and
the head is connected to an end of the tube.

7. The stylus of claim 1, wherein the shaft has a first member and a second member; the jacket is provided on a surface of the first member; the first member has a room therein, and the room is open at a rear end of the first member; the connector unit is received in the room; the second member detachably engages the first member to close the room; and the head is connected to a front end of the first member.

8. The stylus of claim 7, wherein the connector unit further has a wire with opposite ends connected to the first connector and the second connector respectively.

9. The stylus of claim 1, wherein the jacket is made of a material selected from the group consisting of conductive PET, conductive TPR, conductive PE, conductive PVC, and conductive PP.

10. The stylus of claim 1, wherein the conductive skin layer of the head is made of conductive silicone.
